(19) United States
(12) Patent Application Publication
(10) Pub. No.: US 2026/0011856 A1
(43) Pub. Date: Jan. 8, 2026

(54) ENERGY STORAGE APPARATUS

(71) Applicant: GS Yuasa International Ltd., Kyoto-shi (JP)

(72) Inventors: Koki MAEDA, Kyoto-shi (JP); Shohei YAMAO, Kyoto-shi (JP); Junpei YOKOYAMA, Kyoto-shi (JP)

(21) Appl. No.: 19/331,540

(22) Filed: Sep. 17, 2025

Related U.S. Application Data
(63) Continuation of application No. PCT/JP2024/009829, filed on Mar. 13, 2024.

(30) Foreign Application Priority Data
Mar. 24, 2023 (JP) 2023-048600

(51) Int. Cl. H01M 50/291; H01M 10/658; H01M 50/209; H01M 50/242; H01M 50/244; H01M 50/588; H01M 50/593

(52) U.S. Cl. CPC H01M 50/291; H01M 10/658; H01M 50/209; H01M 50/242; H01M 50/244; H01M 50/588; H01M 50/593

(57) ABSTRACT

An energy storage apparatus includes a plurality of energy storage devices, and a spacer located between the plurality of energy storage devices in a first direction. The spacer includes a spacer main body, a first convex portion projecting from the spacer main body toward one side in the first direction, and a second convex portion projecting from the spacer main body toward another side in the first direction. The first convex portion and the second convex portion are located at different positions in at least one of a second direction or a third direction that are two directions perpendicular or substantially perpendicular to the first direction and perpendicular or substantially perpendicular to each other.

### CROSS REFERENCE TO RELATED APPLICATIONS

This application claims the benefit of priority to Japanese Patent Application No. 2023-048600 filed on Mar. 24, 2023 and is a Continuation application of PCT Application No. PCT/JP2024/009829 filed on Mar. 13, 2024. The entire contents of each application are hereby incorporated herein by reference.

### BACKGROUND OF THE INVENTION

### 1. Field of the Invention

The present invention relates to energy storage apparatuses.

### 2. Description of the Related Art

Conventionally, there has been widely known an energy storage apparatus including a plurality of energy storage devices and a spacer located between the plurality of energy storage devices. JP-A-2019-96431 discloses a battery pack in which a spacer is located between a plurality of unit cells, and a plurality of convex portions projecting toward the unit cells located on both sides of the spacer is provided on both surfaces of the spacer.

### SUMMARY OF THE INVENTION

In an energy storage apparatus, when a dimensional variation of an energy storage device is large, there is a problem that a variation of a pressing force on the energy storage device by the spacer is increased. If the dimension of the energy storage device becomes larger, the pressing force by the spacer may be excessively increased. If the dimension of the energy storage device becomes smaller, the spacer may not be able to sufficiently press the energy storage device. In the conventional energy storage apparatus disclosed in JP-A-2019-96431, a plurality of convex portions is provided on both surfaces of the spacer. However, when a dimensional variation of the energy storage device is large, a variation of a pressing force on the energy storage device by the convex portions of the spacer is increased.

Example embodiments of the present invention provide energy storage apparatuses each capable of absorbing a dimensional variation of an energy storage device.

An energy storage apparatus according to an example embodiment of the present invention includes a plurality of energy storage devices, and a spacer located between the plurality of energy storage devices in a first direction, in which the spacer includes a spacer main body, a first convex portion projecting from the spacer main body toward one side in the first direction, and a second convex portion projecting from the spacer main body toward another side in the first direction, and the first convex portion and the second convex portion are located at different positions in at least one of a second direction or a third direction that are two directions perpendicular or substantially perpendicular to the first direction and perpendicular or substantially perpendicular to each other.

According to an energy storage apparatus of an example embodiment of the present invention, a dimensional variation of the energy storage device can be absorbed.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an external appearance of an energy storage apparatus according to an example embodiment of the present invention.

FIG. 2 is an exploded perspective view illustrating individual elements in a case where an energy storage apparatus according to an example embodiment is disassembled.

FIG. 3 is a perspective view illustrating a configuration of an energy storage device according to an example embodiment of the present invention.

FIG. 4 is a perspective view illustrating a configuration of a spacer according to an example embodiment of the present invention.

FIG. 5 is a perspective view illustrating a configuration of a spacer according to an example embodiment of the present invention.

FIGS. 6A and 6B are a front view and a rear view illustrating a configuration of the spacer according to an example embodiment of the present invention.

FIGS. 7A and 7B are a front view and a rear view illustrating a configuration of a spacer according to a modification example of an example embodiment of the present invention.

FIGS. 8A and 8B are a front view and a rear view illustrating a configuration of the spacer according to a modification example of an example embodiment of the present invention.

### DETAILED DESCRIPTION OF THE EXAMPLE EMBODIMENTS

(1) An energy storage apparatus according to an example embodiment of the present invention includes a plurality of energy storage devices, and a spacer located between the plurality of energy storage devices in a first direction, in which the spacer includes, a spacer main body, a first convex portion projecting from the spacer main body toward one side in the first direction, and a second convex portion projecting from the spacer main body toward another side in the first direction, and the first convex portion and the second convex portion are located at different positions in at least one of a second direction or a third direction that are two directions perpendicular or substantially perpendicular to the first direction and perpendicular or substantially perpendicular to each other.

In an energy storage apparatus according to an example embodiment of the present invention, the spacer includes the first convex portion and the second convex portion projecting from the spacer main body toward one side and another side in the first direction, and the first convex portion and the second convex portion are located at different positions in at least one of the second direction or the third direction. As described above, by locating the first convex portion and the second convex portion of the spacer at different positions in at least one of the second direction or the third direction, the first convex portion and the second convex portion are easily deformed mutually in the first direction. As a result, a dimensional variation of the energy storage device can be absorbed by the spacer.

(2) In the energy storage apparatus according to (1) described above, the spacer may include a plurality of the first convex portions, and the plurality of the first convex portions may include a long convex portion extending in the second direction, and a short convex portion located in the second direction of the long convex portion as viewed in the third direction and having a length shorter in the second direction than a length of the long convex portion.

According to the energy storage apparatus according to (2) described above, the plurality of the first convex portions included in the spacer includes the long convex portion that is long in the second direction, and the short convex portion that is located in the second direction of the long convex portion as viewed from the third direction and is shorter in the second direction than the long convex portion. In this manner, by locating the convex portions (the long convex portion and the short convex portion) having different lengths in the second direction on the spacer, convex portions having lengths corresponding to dimensional variations of the energy storage device can be located even when the dimensional variation of the energy storage device in the second direction is complicated.

(3) In the energy storage apparatus according to (2) described above, the plurality of the first convex portions may include two of the short convex portions, and the long convex portion may be located between the two of the short convex portions as viewed from the third direction.

According to the energy storage apparatus according to (3) described above, a dimensional variation of the energy storage device is larger in a central portion than that in an end portion of the energy storage device. Accordingly, a relatively small dimensional variation of the energy storage device can be absorbed by the short convex portion of the spacer, and a relatively large dimensional variation of the energy storage device can be absorbed by the long convex portion of the spacer. Since the central portion of the energy storage device expands more than the end portion, expansion of the energy storage device can be reduced or prevented by the long convex portion of the spacer.

(4) In the energy storage apparatus according to (2) or (3) described above, a projecting length from the spacer main body may be different between the long convex portion and the short convex portion.

According to the energy storage apparatus according to (4) described above, by making a difference in projecting length between the long convex portion and the short convex portion of the spacer, convex portions having projecting lengths corresponding to dimensional variations of the energy storage device can be provided even when the dimensional variation of the energy storage device is complicated.

(5) In the energy storage apparatus according to any one of (2) to (4) described above, each of the plurality of energy storage devices may include a container, and a center position of the long convex portion may be located at a position different from a center position of the container in the second direction.

According to the energy storage apparatus according to (5) described above, when a dimensional variation of the energy storage device is uneven in the second direction, the center position of the long convex portion of the spacer is located at a position different from the center position of the container of the energy storage device. As a result, it is possible to reduce or prevent unevenness in dimensional variation of the energy storage device in the second direction. Even when expansion of the energy storage device is uneven in the second direction, the expansion of the energy storage device can be more uniformly reduced or prevented by the long convex portion.

(6) In the energy storage apparatus according to any one of (1) to (5) described above, each of the plurality of energy storage devices may include a container in which a joint portion joining two portions is included, and at least one of the first convex portion or the second convex portion may extend toward the joint portion.

According to the energy storage apparatus according to (6) described above, the convex portion (at least one of the first convex portion or the second convex portion) of the spacer extends toward the joint portion of the container of the energy storage device, such that the convex portion is located near the joint portion. As a result, even when the container of the energy storage device expands, the convex portion can reduce or prevent expansion near the joint portion of the container, which makes it possible to reduce or prevent damage of the joint portion.

(7) In the energy storage apparatus according to any one of (1) to (6) described above, the spacer may include two second convex portions, and the first convex portion may be located between the two second convex portions in at least one of the second direction or the third direction.

According to the energy storage apparatus according to (7) described above, by locating the first convex portion between the two second convex portions in the spacer, the first convex portion is deformed mutually in the first direction between the two second convex portions. As a result, the first convex portion can be more stably deformed.

Hereinafter, energy storage apparatuses according to example embodiments of the present invention (including modification examples thereof) will be described with reference to the drawings. Each of the example embodiments described below illustrates a comprehensive or specific example. Numerical values, shapes, materials, elements, disposition positions and connection modes of the elements, manufacturing processes, the order of the manufacturing processes, and the like shown in the following example embodiments are merely examples, and are not intended to limit the present invention. In each figure, dimensions and the like are not strictly illustrated. In each figure, identical or similar elements are denoted by same reference numerals.

In the following description and drawings, an arranging direction of a pair of terminals included in the energy storage device or a facing direction of a pair of short side surfaces of the container of the energy storage device is defined as an X-axis direction. A facing direction of a pair of long side surfaces of the container of the energy storage device, a thickness direction (flat direction) of the energy storage device or the spacer, or an arranging direction of the energy storage device and the spacer is defined as a Y-axis direction. A projecting direction of a terminal of the energy storage device, an arranging direction of a container main body portion and a container lid portion of the energy storage device, an arranging direction of a case main body and a lid body of a case, a facing direction of an opening and a bottom wall of the case main body, or a vertical direction is defined as a Z-axis direction. The X-axis direction, the Y-axis direction, and the Z-axis direction are directions intersecting (perpendicular or substantially perpendicular, in the present example embodiment) each other. Although the Z-axis direction may not be in the vertical direction depending on a usage mode, the Z-axis direction will be described below as the vertical direction for convenience of description.

In the following description, an X-axis positive direction indicates an arrow direction of the X-axis, and an X-axis negative direction indicates a direction opposite to the X-axis positive direction. Simply referring to the X-axis direction refers to either or both of the X-axis positive direction and the X-axis negative direction. This similarly applies to the Y-axis direction and the Z-axis direction. Hereinafter, the Y-axis direction is also referred to as a first direction, the Z-axis direction is also referred to as a second direction, and the X-axis direction is also referred to as a third direction. Strictly speaking, expressions indicating relative directions or postures, such as parallel and orthogonal, include cases of not being in the directions or the postures. A state where two directions are parallel not only means a state where the two directions are completely parallel, but also means a state where the two directions are substantially parallel, that is, include a difference of about several percent. In the following description, the expression “insulation” means “electrical insulation”.

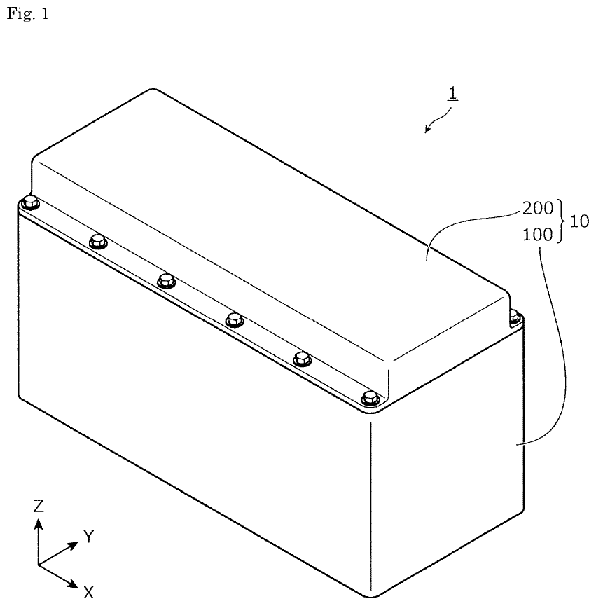

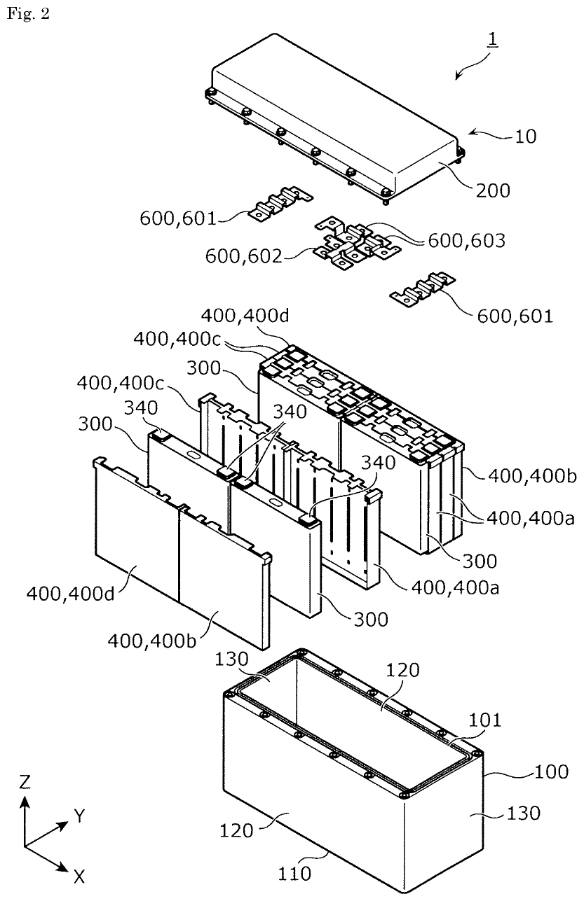

First, a schematic configuration of an energy storage apparatus 1 according to the present example embodiment will be described. FIG. 1 is a perspective view illustrating an external appearance of the energy storage apparatus 1 according to the present example embodiment. FIG. 2 is an exploded perspective view illustrating individual elements in a case where the energy storage apparatus 1 according to the present example embodiment is disassembled.

The energy storage apparatus 1 is an apparatus that can be charged with electricity from an outside and discharge electricity to the outside, and has a substantially rectangular parallelepiped shape in the present example embodiment. The rectangular parallelepiped referred to herein is a hexahedron in which all surfaces are rectangular or square. The energy storage apparatus 1 is a battery module (assembled battery) that is used for power storage application, power supply application, or the like. The energy storage apparatus 1 is used as a battery or the like for driving or starting an engine of a mobile body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and a fossil fuel (gasoline, light oil, liquefied natural gas, or the like) automobile. Examples of the railway vehicle for an electric railway include a train, a monorail, a linear motor car, and a hybrid train including both a diesel engine and an electric motor. The energy storage apparatus 1 can also be used as a stationary battery or the like that is used for home use, business use, or the like.

As illustrated in FIG. 1, the energy storage apparatus 1 includes a case 10. As illustrated in FIG. 2, a plurality of energy storage devices 300, a plurality of spacers 400 (400a to 400d), a plurality of bus bars 600 (601 to 603), and the like are accommodated inside the case 10. The energy storage apparatus 1 also includes external terminals (a positive electrode external terminal and a negative electrode external terminal) and the like for electrical connection an with external device, but illustration and description thereof are omitted. In addition to the above-described elements, the energy storage apparatus 1 may include: a restriction member (an end plate, a side plate, or the like) that restricts the plurality of energy storage devices 300; a bus bar holder that holds the bus bars 600; a bus bar cover; an exhaust portion that exhausts gas discharged from the energy storage devices 300 outward of the case 10; and the like. The energy storage apparatus 1 may include electric components such as a circuit board, a relay, a fuse, a shunt resistor, and a connector that monitor or control a charge state, a discharge state, and the like of the energy storage device 300.

The case 10 is a container (module case) having a substantially rectangular parallelepiped shape (box shape) that forms an outer case (casing, outer shell) of the energy storage apparatus 1. The case 10 is disposed outward of the plurality of energy storage devices 300, the plurality of spacers 400, and the like, fixes the plurality of energy storage devices, the plurality of spacers, and the like at predetermined positions, and protects the plurality of energy storage devices 300, the plurality of spacers 400, and the like from an impact or the like. The case 10 is a metal case formed by a metal member such as aluminum, an aluminum alloy, stainless steel, iron, or a plated steel plate. In the present example embodiment, the case 10 is formed by casting aluminum, specifically, by die-casting (aluminum die-casting). The case 10 may be formed by a member having insulating properties, such as any resin material that can be employed for the spacer 400 described later.

As illustrated in FIG. 1, the case 10 includes a case main body 100 forming a main body of the case 10, and a lid body 200 forming a lid body of the case 10. The case main body 100 is a bottomed rectangular cylindrical housing (casing) in which an opening 101 is formed in the Z-axis positive direction, and accommodates the plurality of energy storage devices 300, the plurality of spacers 400, and the like. Specifically, the case main body 100 includes a flat rectangular bottom wall 110 in the Z-axis negative direction, side walls 120 that are a pair of flat rectangular long side walls on both sides in the Y-axis direction, and side walls 130 that are a pair of flat rectangular short side walls on both sides in the X-axis direction. The bottom wall 110 and the side walls 120 and 130 may have any shape in accordance with a configuration of contents of the case main body 100, and the side wall 120 may be a short side wall and the side wall 130 may be a long side wall. The lid body 200 is a flat rectangular member that closes the rectangular opening 101 of the case main body 100. The case main body 100 and the lid body 200 are joined by screwing or the like with a bolt. As a result, the case 10 has a structure in which an inside is hermetically closed (sealed). The case main body 100 and the lid body 200 may be joined by welding, bonding, or the like. The case main body 100 and the lid body 200 may be formed by members of the same material or different materials.

The energy storage device 300 is a secondary battery (battery cell) that can be charged with electricity and discharge electricity, and more specifically, is a nonaqueous electrolyte secondary battery such as a lithium ion secondary battery. The energy storage device 300 has a shape in which a length in the X-axis direction is longer than a length in the Y-axis direction, specifically, a rectangular parallelepiped shape (prismatic shape) that is flat in the Y-axis direction. In the present example embodiment, eight energy storage devices 300 are arranged side by side in the X-axis direction and the Y-axis direction. Specifically, two (two sets) of energy storage device arrays are arranged in the X-axis direction, in which each energy storage device array includes four energy storage devices 300 arranged in the Y-axis direction. A size and a shape of the energy storage device 300, the number of the energy storage devices 300 arranged, and the like are not particularly limited, and the energy storage device 300 may have an oval columnar shape, an elliptic columnar shape, or a polygonal columnar shape other than the rectangular parallelepiped. The energy storage device 300 is not limited to the nonaqueous electrolyte secondary battery, and may be a secondary battery other than the nonaqueous electrolyte secondary battery, or may be a capacitor. The energy storage device 300 may be not a secondary battery but a primary battery that can use stored electricity without being charged by a user. The energy storage device 300 may be a battery using a solid electrolyte. The energy storage device 300 may be a pouch type energy storage device. A configuration of the energy storage device 300 will be described in detail later.

The spacer 400 is a member that is arranged side by side with the energy storage device 300 in the Y-axis direction, performs electrical insulation and/or thermal insulation between the energy storage device 300 and other members, and is flat in the Y-axis direction (as viewed in the X-axis direction and the Z-axis direction). The spacer 400 is an electrical insulation plate or a thermal insulation plate that is disposed adjacent to the energy storage device 300 in the Y-axis positive direction or the Y-axis negative direction of the energy storage device 300, to perform electrical insulation and/or thermal insulation between the energy storage devices 300 or between the energy storage device 300 and the case 10. The spacer 400 is formed using an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), an ABS resin, or a composite material thereof, or a member having heat insulating properties such as mica, or the like. The spacer 400 includes walls on both sides in the X-axis direction and on both sides in the Z-axis direction of the energy storage device 300, and thus also has a function of a holder that holds the energy storage device 300 and positions the energy storage device 300.

Hereinafter, among the five spacers 400 in the X-axis positive direction, the spacer 400 located between a plurality of (two) energy storage devices 300 in the Y-axis direction (first direction) is also referred to as a spacer 400a. Among the five spacers 400 in the X-axis positive direction, the spacers 400 disposed at both end portions in the Y-axis direction (each between the energy storage device 300 at an end portion and the side wall 120 of the case 10) are also referred to as spacers 400b. In the present example embodiment, the three spacers 400a and the two spacers 400b are alternately arranged side by side with the four energy storage devices 300, but the arrangement positions, the number, and the like of the spacers 400a and 400b are not particularly limited. Among the five spacers 400 in the X-axis negative direction, the spacer 400 located between a plurality of (two) energy storage devices 300 in the Y-axis direction (first direction) is also referred to as a spacer 400c. Among the five spacers 400 in the X-axis negative direction, the spacers 400 disposed at both end portions in the Y-axis direction (each between the energy storage device 300 at an end portion and the side wall 120 of the case 10) are also referred to as spacers 400d. In the present example embodiment, the three spacers 400c and the two spacers 400d are alternately arranged side by side with the four energy storage devices 300, but the arrangement positions, the number, and the like of the spacers 400c and 400d are not particularly limited.

To be more specific, the spacer 400a is an intermediate spacer (intermediate holder) that includes walls on both sides in the X-axis direction and both sides in the Z-axis direction of two energy storage devices 300 disposed on both sides in the Y-axis direction of the spacer 400a, and holds the two energy storage devices 300. This similarly applies to the spacer 400c. The spacer 400b is an end spacer (end holder) that includes walls on both sides in the X-axis direction and both sides in the Z-axis direction of one energy storage device 300 disposed on one side in the Y-axis direction of the spacer 400b, and holds the one energy storage device 300. This similarly applies to the spacer 400d. That is, among the four energy storage devices 300 in the X-axis positive direction, the energy storage devices 300 positioned at the end portions in the Y-axis direction are held by the spacer 400a and the spacer 400b, and other energy storage devices 300 are held by the two spacers 400a. Among the four energy storage devices 300 in the X-axis negative direction, the energy storage devices 300 positioned at the end portions in the Y-axis direction are held by the spacer 400c and the spacer 400d, and other energy storage devices 300 are held by the two spacers 400c. All the spacers 400 (400a to 400d) may be formed by members containing the same material, or any one of the spacers 400 may be formed by a member containing a different material. A configuration of the spacer 400 will be described in detail later.

The bus bars 600 are plate-shaped members connected to the energy storage device 300. The bus bars 600 are disposed above the plurality of energy storage devices 300, and are connected (joined) to terminals 340 of the plurality of energy storage devices 300. To be more specific, the bus bars 600 connect the terminals 340 of the plurality of energy storage devices 300 to each other, and electrically connect the terminals 340 of the energy storage device 300 at an end portion to an external terminal (not illustrated). In the present example embodiment, five bus bars 600 form four sets of energy storage device groups by connecting every two energy storage devices 300 in parallel, and connect the four sets of energy storage device groups in series. Specifically, among the five bus bars 600, a bus bar 601 disposed in the X-axis positive direction connect two sets of energy storage device groups disposed in the X-axis positive direction in series, and a bus bar 601 disposed in the X-axis negative direction connects two sets of energy storage device groups disposed in the X-axis negative direction in series. A bus bar 602 disposed at a central portion in the X-axis direction and in the Y-axis negative direction connects two sets of energy storage device groups disposed in the Y-axis negative direction in series. Two bus bars 603 disposed at a central portion in the X-axis direction and in the Y-axis positive direction respectively connect two sets of energy storage device groups disposed in the Y-axis positive direction to a pair of (a positive electrode and a negative electrode) external terminals (not illustrated) via other bus bars or the like.

A connection mode of the bus bars 600 is not particularly limited, and the plurality of energy storage devices 300 may be connected in series or in parallel in any combination, or all the energy storage devices 300 may be connected in series or in parallel. The bus bars 600 and the terminals 340 are connected (joined) by welding or the like, but a connection mode thereof is not particularly limited. The bus bar 600 is formed using a conductive member made with metal such as aluminum, an aluminum alloy, copper, a copper alloy, or nickel, a combination thereof, a conductive member other than metal, or the like.

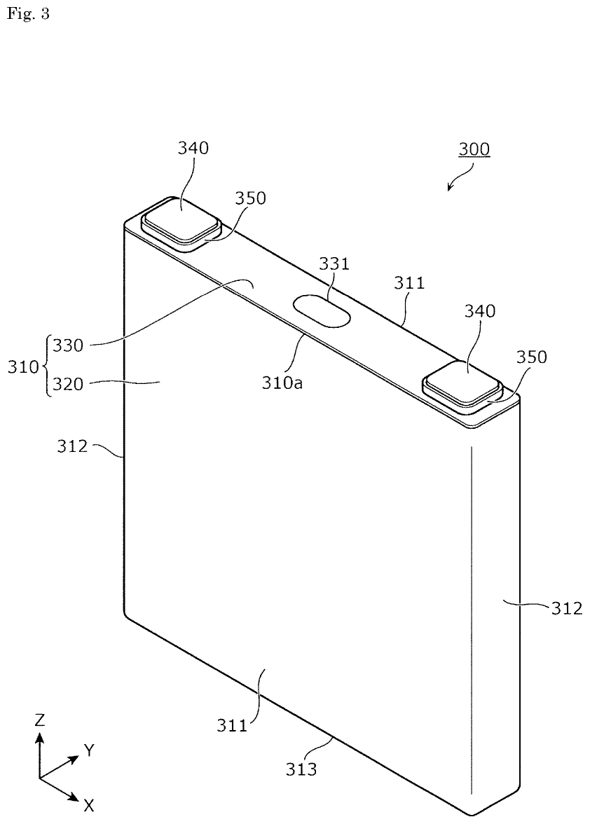

Next, a configuration of the energy storage device 300 will be described in detail. FIG. 3 is a perspective view illustrating a configuration of the energy storage device 300 according to the present example embodiment. FIG. 3 is an enlarged view of the energy storage device 300 illustrated in FIG. 2. All of the plurality of energy storage devices 300 included in the energy storage apparatus 1 has similar configurations. Therefore, FIG. 3 illustrates one energy storage device 300, and a configuration of one energy storage device 300 will be described in detail hereinafter.

As illustrated in FIG. 3, the energy storage device 300 includes a container 310, a pair (a positive electrode and a negative electrode) of terminals 340, and a pair (a positive electrode and a negative electrode) of gaskets 350. An electrode assembly, a pair (a positive electrode and a negative electrode) of current collectors, an electrolyte solution (nonaqueous electrolyte), and the like are accommodated inside the container 310, but illustration thereof is omitted. The electrolyte solution is not particularly limited in type as long as the performance of the energy storage device 300 is not impaired, and various electrolyte solutions can be selected. In addition to the above-described elements, the energy storage device 300 may include a spacer disposed on a side, on a lower side, or the like of the electrode assembly, an insulating film enclosing the electrode assembly and the like, an insulating film (shrink tube or the like) covering an outer surface of the container 310, and the like.

The container 310 is a case having a rectangular parallelepiped shape (a prismatic shape or a box shape) including a container main body portion 320 in which an opening is formed and a container lid portion 330 that closes the opening of the container main body portion 320. The container main body portion 320 is a member having a bottomed rectangular tubular shape and forming a body portion of the container 310, and includes an opening formed in the Z-axis positive direction side. The container lid portion 330 is a rectangular plate-shaped member that forms a lid portion of the container 310 and is long in the X-axis direction, and is disposed in the Z-axis positive direction of the container main body portion 320. The container lid portion 330 is provided with a gas release valve 331 that releases pressure when the pressure inside the container 310 excessively increases, an electrolyte solution filling unit (not illustrated) for filling inside of the container 310 with an electrolyte solution, and the like. A material of the container 310 (the container main body portion 320 and the container lid portion 330) is not particularly limited, and may be weldable (joinable) metal such as stainless steel, aluminum, an aluminum alloy, iron, or a plated steel plate, but resin can also be used.

The container 310 has a structure in which an inside is hermetically closed (sealed) by joining the container main body portion 320 and the container lid portion 330 by welding or the like to form a joint portion 310a, after accommodating the electrode assembly and the like inside the container main body portion 320. The joint portion 310a is a joint portion formed in the container 310 and formed by joining two portions (the container main body portion 320 and the container lid portion 330). In the present example embodiment, the joint portion 310a is formed by emitting laser light from sides (the X-axis direction and the Y-axis direction) of the container 310 to join the container main body portion 320 and the container lid portion 330 by laser welding. The joint portion 310a is a quadrangular annular joint portion formed so as to surround a periphery (entire periphery) of the container 310 at an end portion of the container 310 in the Z-axis positive direction.

The container 310 includes a pair of long side surfaces 311 on both side surfaces in the Y-axis direction, a pair of short side surfaces 312 on both side surfaces in the X-axis direction, and a bottom surface 313 on the Z-axis negative direction side. The long side surface 311 is a rectangular flat surface portion forming a long side surface of the container 310, and is disposed to face an adjacent spacer 400 in the Y-axis direction. The long side surface 311 is adjacent to the short side surface 312 and the bottom surface 313, and has an area larger than that of the short side surface 312. The short side surface 312 is a rectangular flat surface portion forming a short side surface of the container 310, and is disposed to face a wall of the spacer 400 and the side wall 130 of the case 10 in the X-axis direction. The short side surface 312 is adjacent to the long side surface 311 and the bottom surface 313, and has an area smaller than that of the long side surface 311. The bottom surface 313 is a rectangular flat surface portion forming a bottom surface of the container 310, and is disposed so as to face a wall of the spacer 400 and the bottom wall 110 of the case 10 in the Z-axis direction. The bottom surface 313 is disposed adjacent to the long side surface 311 and the short side surface 312.

The terminals 340 are electrode terminals (a positive electrode terminal and a negative electrode terminal) of the energy storage device 300, and are disposed on the container lid portion 330. Specifically, the terminals 340 are disposed in a state of projecting in the Z-axis positive direction from an upper surface (terminal disposition surface) of the container lid portion 330. The terminals 340 are electrically connected respectively to a positive electrode plate and a negative electrode plate of the electrode assembly via a current collector. That is, the terminal 340 is a metal member for leading out electricity stored in the electrode assembly to a space outside the energy storage device 300, and for introducing electricity into a space inside the energy storage device 300 in order to store electricity in the electrode assembly. The terminal 340 is made of aluminum, an aluminum alloy, copper, a copper alloy, or the like.

The electrode assembly is an energy storage element (power generating element) formed by stacking a positive electrode plate, a negative electrode plate, and a separator. The positive electrode plate is made by forming a positive active material layer on a current collecting foil containing metal such as aluminum or an aluminum alloy. The negative electrode plate is made by forming a negative active material layer on a current collecting foil containing metal such as copper or a copper alloy. As the active material used for the positive active material layer and the negative active material layer, a known material can be appropriately used as long as the active material can occlude and release charge transport ions. As the separator, a microporous sheet, nonwoven fabric, or the like made of a resin can be used. In the present example embodiment, the electrode assembly is formed by stacking plates (the positive electrode plate and the negative electrode plate) in the Y-axis direction. The electrode assembly may be an electrode assembly in any form such as a winding-type electrode assembly formed by winding plates (a positive electrode plate and a negative electrode plate), a multilayer-type (stacking-type) electrode assembly formed by stacking a plurality of plate-shaped plates, or a bellows-type electrode assembly formed by folding plates in a bellows shape.

The current collector is a conductive collector member (a positive electrode current collector and a negative electrode current collector) electrically connected to the terminal 340 and the electrode assembly. The positive electrode current collector is formed by aluminum, an aluminum alloy, or the like similarly to the current collecting foil of the positive electrode plate of the electrode assembly, and the negative electrode current collector is formed by copper, a copper alloy or the like similarly to the current collecting foil of the negative electrode plate of the electrode assembly. The gasket 350 is a gasket that is located between the container lid portion 330, and the terminal 340 and the current collector, and insulates the container lid portion 330 from the terminal 340 and the current collector. The gasket 350 may be made by any material as long as insulating properties are provided.

Next, a configuration of the spacer 400 will be described in detail. Among the spacers 400, the spacer 400b has a configuration similar to a half of the spacer 400a in the Y-axis direction (a portion formed by cutting along a plane passing through a center position of the spacer 400a and parallel to an XZ plane). The spacer 400c has a shape that is symmetrical to the spacer 400a in the X-axis direction (symmetrical with respect to a plane parallel to a YZ plane), or a shape obtained by rotating the spacer 400a by 180° about the Z axis. The spacer 400d has a configuration similar to a half of the spacer 400c in the Y-axis direction (a portion formed by cutting along a plane passing through a center position of the spacer 400c and parallel to the XZ plane). Therefore, hereinafter, the configuration of the spacer 400a will be described in detail, and description of the configurations of the spacer 400b, the spacer 400c, and the spacer 400d will be simplified or omitted.

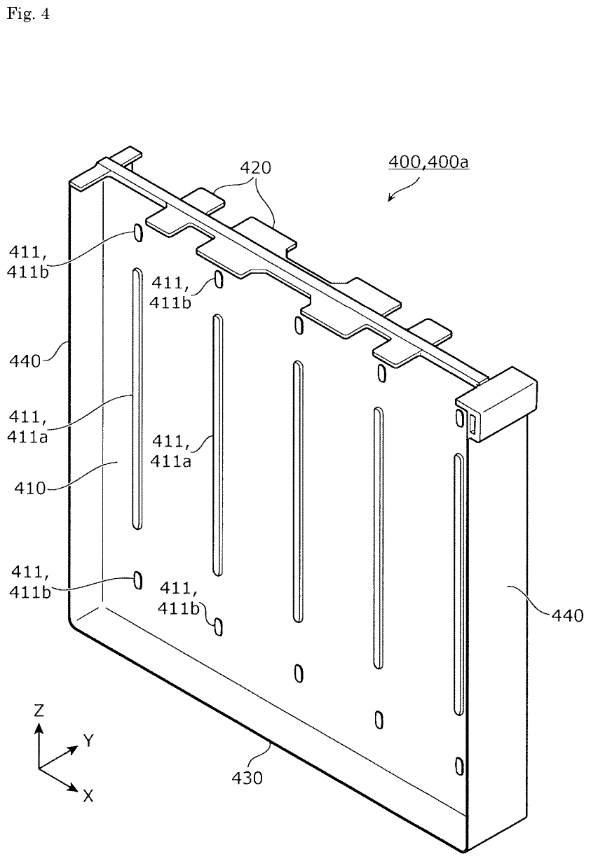

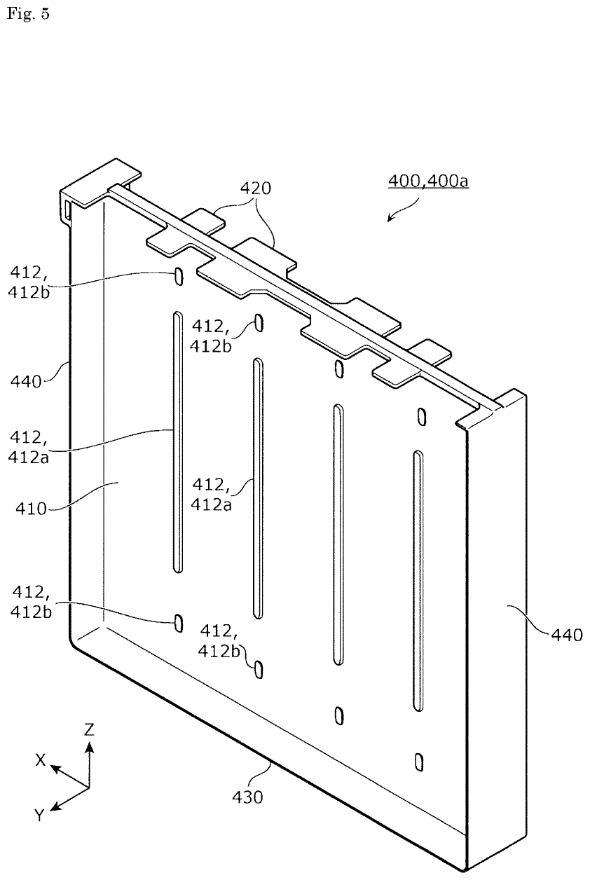

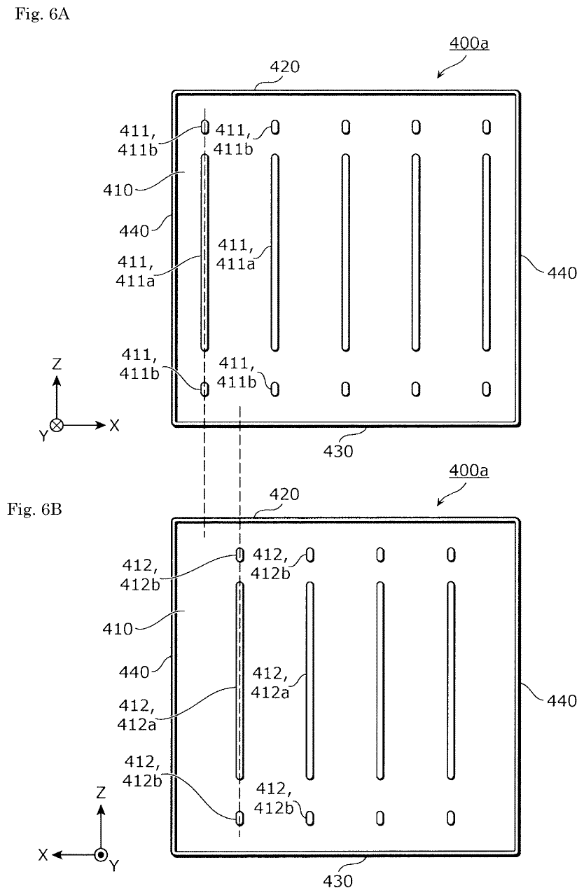

FIGS. 4 and 5 are perspective views illustrating a configuration of the spacer 400a according to the present example embodiment. Specifically, FIG. 4 is an enlarged perspective view illustrating the spacer 400a illustrated in FIG. 2. FIG. 5 is a perspective view illustrating a configuration in a case where the spacer 400a illustrated in FIG. 4 is rotated by 180° about the Z axis. That is, FIG. 4 illustrates a surface of the spacer 400a in the Y-axis negative direction, and FIG. 5 illustrates a surface of the spacer 400a in the Y-axis positive direction (a back surface of the spacer 400a in FIG. 4). FIGS. 6A and 6B are front views and a rear views illustrating a configuration of the spacer 400a according to the present example embodiment. Specifically, FIG. 6A is a front view illustrating a configuration when the spacer 400a in FIG. 4 is viewed from the Y-axis negative direction, and FIG. 6B is a rear view illustrating a configuration when the spacer 400a in FIG. 5 is viewed from the Y-axis positive direction.

As illustrated in FIGS. 4 to 6, the spacer 400a includes a spacer main body 410 and spacer walls 420 to 440 disposed on both sides in the Z-axis direction and both sides in the X-axis direction of the energy storage device 300. The spacer main body 410 is a flat rectangular portion forming a main body portion of the spacer 400a, and is disposed in parallel to the XZ plane. In the present example embodiment, the spacer main body 410 is disposed in the Y-axis positive direction or the Y-axis negative direction of the energy storage device 300. The spacer main body 410 is formed in substantially the same shape and size as the container 310 of the energy storage device 300 as viewed in the Y-axis direction, and is disposed at substantially the same position as the container 310 of the energy storage device 300. As a result, the spacer main body 410 is disposed to face the long side surface 311 of the container 310 of the energy storage device 300 in the Y-axis direction so as to cover the whole surface of the long side surface 311.

The spacer wall 420 is a flat plate-shaped portion projecting toward both sides in the Y-axis direction from an end portion of the spacer main body 410 in the Z-axis positive direction, and is disposed in parallel to an XY plane. The spacer wall 420 is disposed in the Z-axis positive direction of the container lid portion 330 of the energy storage device 300. The spacer wall 420 is disposed to face the container lid portion 330 in the Z-axis direction. In the present example embodiment, the spacer wall 420 is disposed apart from the container lid portion 330, but may be disposed in contact with the container lid portion 330.

The spacer wall 430 is a flat plate-shaped portion projecting toward both sides in the Y-axis direction from an end portion of the spacer main body 410 in the Z-axis negative direction, and is disposed in parallel to the XY plane. The spacer wall 430 is a long portion extending in the X-axis direction from one end to another end of the spacer main body 410 in the X-axis direction. The spacer wall 430 is located between the bottom surface 313 of the container 310 of the energy storage device 300 and the bottom wall 110 of the case main body 100 of the case 10, so as to face the bottom surface 313 and the bottom wall 110 in the Z-axis direction. In the present example embodiment, the spacer wall 430 is disposed in contact with the bottom surface 313 and the bottom wall 110.

The spacer walls 440 are flat plate-shaped portions projecting from both end portions of the spacer main body 410 in the X-axis direction toward both sides in the Y-axis direction, and are disposed parallel to the YZ plane. The spacer wall 440 is a long portion extending in the Z-axis direction from one end to another end of the spacer main body 410 in the Z-axis direction. The spacer wall 440 is disposed on the short side surface 312 of the container 310 of the energy storage device 300 in the X-axis direction. The spacer wall 440 is disposed to face the short side surface 312 in the X-axis direction. That is, a pair of spacer walls 440 are disposed at positions sandwiching a pair of short side surfaces 312 of the container 310 in the X-axis direction. In the present example embodiment, the spacer wall 440 is disposed in contact with the short side surface 312, but may be disposed apart from the short side surface 312. In this manner, the spacer walls 420 to 440 are disposed so as to surround both sides in the Z-axis direction and both sides in the X-axis direction of the energy storage device 300, and hold the energy storage device 300.

The spacer 400a further includes a convex portion projecting in the Y-axis direction (first direction) from the spacer main body 410. To be more specific, the spacer 400a includes: a first convex portion 411 projecting in the Y-axis negative direction (one side in the first direction) from the spacer main body 410; and a second convex portion 412 projecting in the Y-axis positive direction (another side in the first direction) from the spacer main body 410. The first convex portion 411 and the second convex portion 412 are protrusions (ribs) extending in the Z-axis direction (second direction). The first convex portion 411 and the second convex portion 412 are disposed in a state of being in contact with the long side surface 311 of the container 310 of the energy storage device 300 in the Y-axis direction. As described above, the spacer main body 410 is disposed at substantially the same position as the container 310 of the energy storage device 300 as viewed in the Y-axis direction, and the joint portion 310a is disposed at the end portion of the container 310 of the energy storage device 300 in the Z-axis positive direction. Therefore, at least one (both, in the present example embodiment) out of the first convex portion 411 and the second convex portion 412 extends in the Z-axis direction toward the joint portion 310a.

The first convex portion 411 and the second convex portion 412 are located at different positions in at least one of the Z-axis direction (second direction) and the X-axis direction (third direction) which are two directions perpendicular or substantially perpendicular the Y-axis direction (first direction) and perpendicular or substantially perpendicular to each other. To be more specific, the spacer 400a includes two second convex portions 412, and the first convex portion 411 is located between the two second convex portions 412 in at least one of the Z-axis direction (second direction) and the X-axis direction (third direction). In the present example embodiment, the first convex portion 411 and the second convex portion 412 are disposed at the same position in the Z-axis direction (second direction) and different positions in the X-axis direction (third direction). As a result, the first convex portion 411 is located between the two second convex portions 412 in the X-axis direction (third direction). Specifically, the spacer 400a includes a plurality of first convex portions 411 and a plurality of second convex portions 412, and the plurality of first convex portions 411 and the plurality of second convex portions 412 are alternately disposed in the X-axis direction. That is, in the X-axis direction, the first convex portion 411 is located between two second convex portions 412, and the second convex portion 412 is located between two first convex portions 411. In the present example embodiment, the plurality of first convex portions 411 and the plurality of second convex portions 412 are alternately disposed at equal intervals in the X-axis direction.

The plurality of first convex portions 411 includes a plurality of first long convex portions 411a and a plurality of first short convex portions 411b. The first long convex portion 411a is an elongated linear protrusion (rib) projecting from the spacer main body 410 in the Y-axis negative direction and extending in the Z-axis direction (second direction). At a center position of the spacer main body 410 in the Z-axis direction, a plurality of (five) first long convex portions 411a is arranged side by side at equal intervals in the X-axis direction, from one end portion to another end portion of the spacer main body 410 in the X-axis direction.

The first short convex portion 411b is a dot-shaped protrusion (rib) projecting from the spacer main body 410 in the Y-axis negative direction and having a shorter length in the Z-axis direction (second direction) than the first long convex portion 411a. In the present example embodiment, the first short convex portion 411b has an oval shape elongated in the Z-axis direction as viewed from the Y-axis direction, but may have an elliptical shape elongated in the Z-axis direction, an oval shape or an elliptical shape elongated in the X-axis direction, a circular shape, a polygonal shape such as a rectangular shape, or the like. The first short convex portion 411b is disposed in the Z-axis direction (second direction) of the first long convex portion 411a as viewed in the X-axis direction (third direction). Specifically, the first short convex portion 411b is disposed at an end portion of the spacer main body 410 in the Z-axis direction with respect to the first long convex portion 411a.

In the present example embodiment, for each of the first long convex portions 411a, two first short convex portions 411b are disposed on both sides in the Z-axis direction of the first long convex portion 411a (both end portions in the Z-axis direction of the spacer main body 410). That is, the plurality of first convex portions 411 includes two first short convex portions 411b, and the first long convex portion 411a is located between the two first short convex portions 411b as viewed in the X-axis direction (third direction). As a result, at an end portion of the spacer main body 410 in the Z-axis positive direction, a plurality of (five) first short convex portions 411b is arranged side by side at equal intervals in the X-axis direction, from one end portion to another end portion of the spacer main body 410 in the X-axis direction. Similarly, at an end portion of the spacer main body 410 in the Z-axis negative direction, a plurality of (five) first short convex portions 411b is arranged side by side at equal intervals in the X-axis direction, from one end portion to another end portion of the spacer main body 410 in the X-axis direction.

The first long convex portion 411a is preferably disposed at a position where the first long convex portion 411a overlaps with the electrode assembly (particularly a flat portion thereof) of the energy storage device 300 as viewed in the Y-axis direction, and the first short convex portion 411b is preferably disposed at a position where the first short convex portion 411b does not overlap with the electrode assembly (particularly the flat portion thereof) as viewed in the Y-axis direction. The flat portion of the electrode assembly is a flat portion excluding a connection portion (tab or the like) between with the current collector in a case where the electrode assembly is of a stacked type or a bellows type, and is a flat portion connecting two curved portions positioned at both end portions (excluding a connection portion (tab or the like) between with the current collector) in a case where the electrode assembly is of a winding type.

In the present example embodiment, the first long convex portion 411a is disposed closer to the first short convex portion 411b in the Z-axis positive direction than the first short convex portion 411b in the Z-axis negative direction. That is, in the Z-axis direction, the first long convex portion 411a is disposed such that a center position of the first long convex portion 411a is positioned in the Z-axis positive direction with respect to a center position of the spacer main body 410. As described above, the spacer main body 410 is disposed at substantially the same position as the container 310 of the energy storage device 300 as viewed in the Y-axis direction. Accordingly, in the first long convex portion 411a, the center position of the first long convex portion 411a is disposed at a position (in the present example embodiment, a position shifted in the Z-axis positive direction) different from a center position of the container 310 in the Z-axis direction (second direction). As described above, the first long convex portion 411a and the first short convex portion 411b are disposed at appropriate positions in accordance with a shape of the container 310 of the energy storage device 300.

Between the first long convex portion 411a and the first short convex portion 411b, a projecting length (length in a projecting direction (Y-axis direction)) from the spacer main body 410 is different. In the present example embodiment, the projecting length (length in the projecting direction (Y-axis direction)) of the first long convex portion 411a from the spacer main body 410 is longer than that of the first short convex portion 411b. The projecting length of the first long convex portion 411a is 1.1 times or more the projecting length of the first short convex portion 411b. Depending on the shape of the container 310 of the energy storage device 300, the projecting length (the length in the projecting direction (Y-axis direction)) of the first short convex portion 411b from the spacer main body 410 may be longer than that of the first long convex portion 411a. In this manner, the first long convex portion 411a and the first short convex portion 411b are formed to have an appropriate projecting length in accordance with the shape of the container 310 of the energy storage device 300.

Similarly, the plurality of second convex portions 412 includes a plurality of second long convex portions 412a and a plurality of second short convex portions 412b. The second long convex portion 412a is an elongated linear protrusion (rib) projecting from the spacer main body 410 in the Y-axis positive direction and extending in the Z-axis direction (second direction). The second short convex portion 412b is a dot-shaped protrusion (rib) projecting from the spacer main body 410 in the Y-axis positive direction and having a shorter length in the Z-axis direction (second direction) than the second long convex portion 412a. In the present example embodiment, the second long convex portion 412a and the second short convex portion 412b have the same shape and size as those of the first long convex portion 411a and the first short convex portion 411b, and are disposed at positions shifted in the X-axis direction from the positions where the first long convex portion 411a and the first short convex portion 411b are disposed as viewed in the Y-axis direction.

That is, the second short convex portion 412b is disposed in the Z-axis direction (second direction) of the second long convex portion 412a as viewed in the X-axis direction (third direction). The plurality of second convex portions 412 includes two second short convex portions 412b, and the second long convex portion 412a is located between the two second short convex portions 412b as viewed in the X-axis direction (third direction). Specifically, at a center position of the spacer main body 410 in the Z-axis direction, a plurality of (four) second long convex portions 412a is arranged side by side at equal intervals in the X-axis direction, from one end portion to another end portion of the spacer main body 410 in the X-axis direction. At an end portion of the spacer main body 410 in the Z-axis positive direction, a plurality of (four) second short convex portions 412b is arranged side by side at equal intervals in the X-axis direction, from one end portion to another end portion of the spacer main body 410 in the X-axis direction. At an end portion of the spacer main body 410 in the Z-axis negative direction, a plurality of (four) second short convex portions 412b is arranged side by side at equal intervals in the X-axis direction, from one end portion to another end portion of the spacer main body 410 in the X-axis direction.

In the second long convex portion 412a, a center position of the second long convex portion 412a is disposed at a position (in the present example embodiment, a position shifted in the Z-axis positive direction) different from the center position of the container 310 in the Z-axis direction (second direction). Between the second long convex portion 412a and the second short convex portion 412b, a projecting length (length in a projecting direction (Y-axis direction)) from the spacer main body 410 is different. In the present example embodiment, the second long convex portion 412a has a larger projecting length from the spacer main body 410 than that of the second short convex portion 412b, but the second short convex portion 412b may have a longer projecting length from the spacer main body 410 than that of the second long convex portion 412a. The second long convex portion 412a and the second short convex portion 412b have the same shape and size as those of the first long convex portion 411a and the first short convex portion 411b, and thus, further detailed description thereof will be omitted. The second long convex portion 412a and the second short convex portion 412b may have a shape or a size different from those of the first long convex portion 411a and the first short convex portion 411b.

As described above, according to the energy storage apparatus 1 of the present example embodiment, the spacer 400a includes the first convex portion 411 and the second convex portion 412 respectively projecting in the Y-axis negative direction and the Y-axis positive direction (one side in the first direction and another side in the first direction) from the spacer main body 410. The first convex portion 411 and the second convex portion 412 are located at different positions in at least one direction (X-axis direction in the present example embodiment) out of the Z-axis direction (second direction) and the X-axis direction (third direction). As described above, by disposing the first convex portion 411 and the second convex portion 412 of the spacer 400a at different positions in at least one direction (X-axis direction in the present example embodiment) out of the Z-axis direction (second direction) and the X-axis direction (third direction), the first convex portion 411 and the second convex portion 412 are easily deformed in the Y-axis direction (first direction). As a result, a dimensional variation of the energy storage device 300 can be absorbed by the spacer 400a.

Since the first convex portion 411 and the second convex portion 412 of the spacer 400a are easily deformed mutually in the Y-axis direction, it is possible to prevent the energy storage device 300 from being excessively pressed or the energy storage device 300 from being insufficiently pressed when suppressing expansion of the energy storage device 300, even if there is a dimensional variation in the energy storage device 300. The surfaces (the long side surfaces 311 of the container 310) facing the spacer 400a in the two energy storage devices 300 sandwiching the spacer 400a may have different dimensional variations or may expand differently with respect to the Y-axis direction. In this case, since the first convex portion 411 and the second convex portion 412 of the spacer 400a are easily deformed mutually in the Y-axis direction, it is possible to absorb dimensional variations of the two energy storage devices 300 and suppress expansion.

The plurality of first convex portions 411 of the spacer 400a includes the first long convex portion 411a elongated in the Z-axis direction (second direction), and the first short convex portion 411b disposed in the Z-axis direction of the first long convex portion 411a as viewed in the X-axis direction (third direction) and shorter in the Z-axis direction than the first long convex portion 411a. As described above, by disposing the convex portions (the first long convex portion 411a and the first short convex portion 411b) having different lengths in the Z-axis direction on the spacer 400a, the convex portions having lengths corresponding to dimensional variations of the energy storage device 300 can be disposed even when the dimensional variation of the energy storage device 300 in the Z-axis direction is complicated.

The dimensional variation of the energy storage device 300 is larger in a central portion than that in an end portion of the energy storage device 300. Accordingly, a relatively small dimensional variation of the energy storage device 300 can be absorbed by the first short convex portions 411b of the spacer 400a, and a relatively large dimensional variation of the energy storage device 300 can be absorbed by the first long convex portions 411a of the spacer 400a. Since the central portion of the energy storage device 300 expands more than the end portion thereof, expansion of the energy storage device 300 can be suppressed by the first long convex portion 411a of the spacer 400a.

By making a difference in projecting length between the first long convex portion 411a and the first short convex portion 411b of the spacer 400a, convex portions having projecting lengths corresponding to dimensional variations of the energy storage device 300 can be disposed even when the dimensional variation of the energy storage device 300 is complicated. In a case where the projecting length of the first long convex portion 411a is longer than the projecting length of the first short convex portion 411b, expansion of the energy storage device 300 can be effectively suppressed by the first long convex portion 411a having a relatively long projecting length. In a case where the central portion of the energy storage device 300 slightly expands from the beginning, a convex portion corresponding to the shape of the energy storage device 300 can be disposed by making a projecting length of the first long convex portion 411a shorter than a projecting length of the first short convex portion 411b.

When a dimensional variation of the energy storage device 300 is uneven in the Z-axis direction (second direction), the center position of the first long convex portion 411a of the spacer 400a is disposed at a position different from the center position of the container 310 of the energy storage device 300 in the Z-axis direction. As a result, it is possible to suppress unevenness in dimensional variation of the energy storage device 300 in the Z-axis direction. Even when expansion of the energy storage device 300 is uneven in the Z-axis direction, the expansion of the energy storage device 300 can be more uniformly suppressed by the first long convex portion 411a.

The convex portion (at least one of the first convex portion 411 or the second convex portion 412) of the spacer 400a extends toward the joint portion 310a of the container 310 of the energy storage device 300, whereby the convex portion is disposed near the joint portion 310a. As a result, even when the container 310 of the energy storage device 300 expands, the convex portion can suppress expansion near the joint portion 310a of the container 310, which makes it possible to suppress damage of the joint portion 310a.

In the spacer 400a, the first convex portion 411 is located between the two second convex portions 412, so that the first convex portion 411 is deformed in the Y-axis direction (first direction) between the two second convex portions 412. As a result, the first convex portion 411 can be more stably deformed.

In the above description, the effect of the first convex portion 411 (the first long convex portion 411a and the first short convex portion 411b) can be similarly applied to the second convex portion 412 (the second long convex portion 412a and the second short convex portion 412b). The effect of the spacer 400a can be similarly applied to the spacer 400c.

Although the energy storage apparatuses according to the example embodiments of the present invention have been described above, the present invention is not limited to the example embodiments described above. The example embodiments disclosed herein are merely examples in all respects, and the scope of the present invention includes all modification examples within the meaning and scope equivalent to the claims.

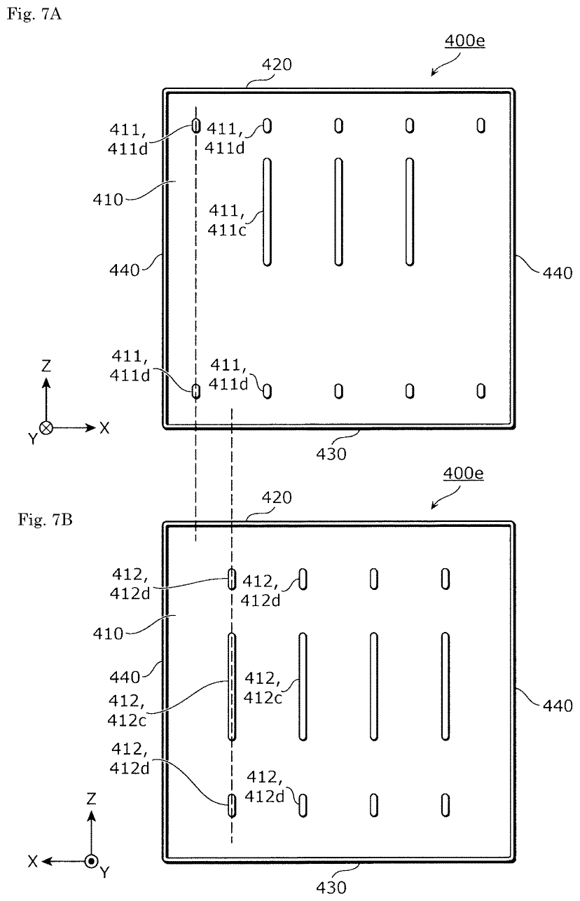

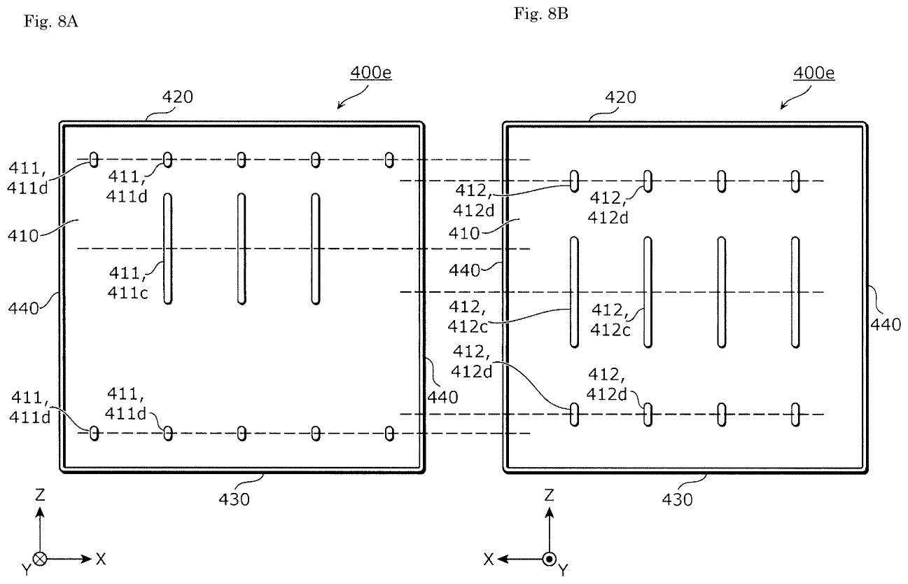

In the example embodiments described above, shapes, sizes, and disposition positions of the first convex portions 411 (the first long convex portions 411a and the first short convex portions 411b) and the second convex portions 412 (the second long convex portions 412a and the second short convex portions 412b) are not limited. FIGS. 7 and 8 are a front view and a rear view illustrating a configuration of a spacer 400e according to a modification example of the present example embodiment.

Specifically, FIGS. 7A and 7B correspond to FIGS. 6A and 6B, respectively. FIGS. 8A and 8B are obtained by horizontally arranging FIGS. 7A and 7B, in order to describe a positional relationship between the first convex portion 411 and the second convex portion 412 in the Z-axis direction.

As illustrated in FIGS. 7 and 8, the first convex portion 411 of the spacer 400e in the present modification example includes a first long convex portion 411c and a first short convex portion 411d instead of the first long convex portion 411a and the first short convex portion 411b of the first convex portion 411 of the spacer 400a in the example embodiments described above. The second convex portion 412 of the spacer 400e in the present modification example includes a second long convex portion 412c and a second short convex portion 412d instead of the second long convex portion 412a and the second short convex portion 412b of the second convex portion 412 of the spacer 400a in the example embodiments described above. Other configurations of the present modification example are similar to those of the example embodiments described above, and thus detailed description thereof is omitted.

The first long convex portion 411c in the present modification example has a shorter length in the Z-axis direction than that of the first long convex portion 411a in the example embodiments described above, and a center position of the first long convex portion 411c is disposed in the Z-axis positive direction with respect to a center position of the first long convex portion 411a. In the example embodiments described above, the five first long convex portions 411a are provided. However, in the present modification example, the first long convex portion 411c is not disposed at both end portions in the X-axis direction of the spacer main body 410, and the three first long convex portions 411c are disposed. Since the first short convex portion 411d in the present modification example has the same shape, size, and disposition position as those of the first short convex portion 411b in the example embodiments described above, detailed description thereof will be omitted. The second long convex portion 412c in the present modification example has a shorter length in the Z-axis direction than the second long convex portion 412a in the example embodiments described above, and a center position of the second long convex portion 412c is disposed at the same position as the center position of the second long convex portion 412a. The second short convex portion 412d in the present modification example has a longer length in the Z-axis direction than the second short convex portion 412b in the example embodiments described above, and is disposed inward of the second short convex portion 412b in the Z-axis direction.

With such a configuration, the first convex portion 411 and the second convex portion 412 are located at different positions in both of the Z-axis direction (second direction) and the X-axis direction (third direction) which are two directions perpendicular or substantially perpendicular the Y-axis direction (first direction) and perpendicular or substantially perpendicular to each other. The first convex portion 411 is located between the two second convex portions 412 in the X-axis direction (third direction). The second short convex portion 412d of the second convex portion 412 is located between the first long convex portion 411c and the first short convex portion 411d of the first convex portion 411 in the Z-axis direction (second direction). The first long convex portion 411c and the second long convex portion 412c are disposed such that center positions of the first long convex portion 411c and the second long convex portion 412c are different from the center position of the container 310 in the Z-axis direction (second direction). A projecting length from the spacer main body 410 is different between the first long convex portion 411c and the first short convex portion 411d, and a projecting length from the spacer main body 410 is different between the second long convex portion 412c and the second short convex portion 412d.

As described above, according to the energy storage apparatus of the present modification example, an effect similar to that of the example embodiments described above can be obtained. In particular, in the present modification example, the first convex portion 411 and the second convex portion 412 are located at different positions also in the Z-axis direction. Therefore, even when two energy storage devices 300 sandwiching the spacer 400e therebetween have a dimensional variation in the Z-axis direction, the dimensional variation of the energy storage devices 300 can be absorbed and expansion can be suppressed. Even when the first long convex portions 411c are not disposed on both end portions of the spacer main body 410 in the X-axis direction, expansion of the energy storage device 300 can be suppressed, and thus the configuration of the spacer 400e can be simplified.

In the example embodiments described above, the first convex portion 411 and the second convex portion 412 extend in the Z-axis direction toward the joint portion 310a of the container 310 of the energy storage device 300, but may extend in a direction inclined from the Z-axis direction, or may extend in the X-axis direction. That is, the first convex portion 411 and the second convex portion 412 may be disposed (alternately disposed) at different positions in a direction inclined from the X-axis direction or in the Z-axis direction.

In the example embodiments described above, the two first short convex portions 411b are disposed on both sides of the first long convex portion 411a in the Z-axis direction, but the disposition positions of the first long convex portion 411a and the first short convex portion 411b are not particularly limited. The two first long convex portions 411a may be disposed on both sides of the first short convex portion 411b in the Z-axis direction. Alternatively, the first short convex portion 411b may be disposed at a position shifted in the X-axis direction from the Z-axis direction of the first long convex portion 411a. That is, the first short convex portion 411b is only required to be disposed in the Z-axis direction of the first long convex portion 411a as viewed in the X-axis direction. The lengths of the first long convex portion 411a and the first short convex portion 411b in the Z-axis direction are also not particularly limited as long as the first long convex portion 411a is longer than the first short convex portion 411b. This similarly applies to the second convex portion 412.

In the example embodiments described above, the spacer 400a includes the plurality of first convex portions 411, and the plurality of first convex portions 411 includes the plurality of first long convex portions 411a and the plurality of first short convex portions 411b. However, the number of the first long convex portions 411a and the number of the first short convex portions 411b are not particularly limited. The spacer 400a may include only one first long convex portion 411a, may include only one first short convex portion 411b, or may not include either one of the first long convex portion 411a and the first short convex portion 411b. This similarly applies to the second convex portion 412.

In the example embodiments described above, in the first long convex portion 411a, the center position of the first long convex portion 411a is disposed at a position shifted in the Z-axis positive direction from the center position of the container 310 of the energy storage device 300 in the Z-axis direction. However, the center position of the first long convex portion 411a may be disposed at a position shifted in the Z-axis negative direction from the center position of the container 310. In the first long convex portion 411a, in the Z-axis direction, the center position of the first long convex portion 411a may be disposed at the same position as the center position of the container 310 of the energy storage device 300. This similarly applies to the second convex portion 412.

In the example embodiments described above, in the plurality of first convex portions 411, the projecting lengths of the plurality of first long convex portions 411a from the spacer main body 410 are the same, but the projecting length of any of the first portions 411a may be different. The projecting lengths from the spacer main body 410 of the plurality of first short convex portions 411b are the same, but the projecting length of any of the first short convex portions 411b may be different. The projecting lengths of the first long convex portion 411a and the first short convex portion 411b from the spacer main body 410 are different, but the projecting lengths may be the same. This similarly applies to the second convex portion 412.

In the example embodiments described above, the spacer 400a includes the spacer wall 420 to 440, but is not limited to having all of these spacer walls. The spacer 400a may not include the spacer wall 420, or may not include one or both of the pair of spacer walls 440. The spacer 400a may not include the spacer wall 430. That is, the spacer 400a may not be a holder that holds the energy storage device 300.

In the example embodiments described above, all the spacers 400a have the configuration described above, but any of the spacers 400a may not have the configuration described above. This similarly applies to the other spacers 400.

In the example embodiments described above, the spacers 400 (the spacers 400a to 400d) are alternately arranged side by side with the energy storage devices 300 in the Y-axis direction. However, the configuration may be adopted in which any one of the spacers 400 is not arranged. Only one spacer 400a (or one spacer 400c) sandwiched between two energy storage devices 300 may be disposed.

In the example embodiments described above, the case 10 includes the case main body 100 and the lid body 200, but may not include the lid body 200. In the example embodiments described above, two energy storage device arrays each including the plurality of energy storage devices 300 are arranged in the X-axis direction inside the case 10. However, three or more energy storage device arrays may be arranged in the X-axis direction, or only one energy storage device array may be arranged. That is, three or more spacers 400 may be arranged in the X-axis direction, or only one spacer 400 may be arranged.

Configurations established by optionally combining the elements included in the example embodiments described above and the modification examples thereof are also included within the scope of the present invention.

Example embodiments of the present invention can be applied to energy storage apparatuses and the like including energy storage devices such as lithium ion secondary batteries.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
a plurality of energy storage devices; and
a spacer located between the plurality of energy storage devices in a first direction; wherein
the spacer includes:
a spacer main body;
a first convex portion projecting from the spacer main body toward one side in the first direction; and
a second convex portion projecting from the spacer main body toward an other side in the first direction; and
the first convex portion and the second convex portion are located at different positions in at least one of a second direction or a third direction that are two directions perpendicular or substantially perpendicular to the first direction and perpendicular or substantially perpendicular to each other.

2. The energy storage apparatus according to claim 1, wherein
the spacer includes a plurality of first convex portions included in the first convex portion; and
the plurality of first convex portions includes:
a long convex portion extending in the second direction; and
a short convex portion located in the second direction of the long convex portion as viewed from the third direction and having a length shorter in the second direction than a length of the long convex portion.

3. The energy storage apparatus according to claim 2,
the plurality of first convex portions includes two short convex portions included in the short convex portion; and
the long convex portion is located between the two short convex portions as viewed from the third direction.

4. The energy storage apparatus according to claim 2, wherein a projecting length from the spacer main body is different between the long convex portion and the short convex portion.

5. The energy storage apparatus according to claim 2, wherein
each of the plurality of energy storage devices includes a container; and
a center position of the long convex portion is located at a position different from a center position of the container in the second direction.

6. The energy storage apparatus according to claim 1, wherein
each of the plurality of energy storage devices includes a container in which a joint portion joining two portions is included; and
at least one of the first convex portion or the second convex portion extends toward the joint portion.

7. The energy storage apparatus according to claim 1, wherein
the spacer includes two second convex portions included in the second convex portion; and
the first convex portion is located between the two second convex portions in at least one of the second direction or the third direction.
